(19) United States
(12) Patent Application Publication
(10) Pub. No.: US 2014/0070552 A1
(43) Pub. Date: Mar. 13, 2014

(54) Bumper

(71) Applicant: Asteer Co., Ltd., Soja-shi (JP)

(72) Inventor: Koji Shimotsu, Soja-shi (JP)

(73) Assignee: Asteer Co., Ltd., Soja-shi (JP)

(21) Appl. No.: 14/024,320

(22) Filed: Sep. 11, 2013

(30) Foreign Application Priority Data
Sep. 12, 2012 (JP) 2012-200630

(51) Int. Cl. B60R 19/03; C21D 1/18

(52) U.S. Cl. CPC B60R 19/03; C21D 1/18
USPC 293/102

(57) ABSTRACT

A bumper for vehicles having a high productivity and a large energy absorption amount in which the reinforcement beam is prevented from buckling. The bumper includes a reinforcement beam made of steel and support members protruding from a vehicle frame and supporting the reinforcement beam therebetween. The reinforcement beam is provided with a quenched portion provided at least over a portion where an obstacle hits the reinforcement beam. The reinforcement beam is further provided with unquenched portions next to the portion where the obstacle hits the reinforcement beam to sandwich the quenched portion. A mechanical strength of the unquenched portions is smaller than the mechanical strength of the quenched portion.

### BACKGROUND OF THE INVENTION

1. Field of the Invention

The present invention relates to a bumper for vehicles including a reinforcement beam made of steel and support members. The support members protrude from a vehicle frame and support the reinforcement beam therebetween.

2. Description of the Related Art

A bumper is, for example, provided at a front end or a back end of a vehicle. The bumper absorbs an impact energy when the vehicle collides with an object. A bumper configured by a reinforcement beam which is totally quenched and supporting members supporting the reinforcement beam therebetween is proposed. This kind of bumpers absorbs the impact energy by plastically deforming or crashing the reinforcement beam or the supporting members. Since a force-stroke curve and a total impact energy absorption amount change in accordance with how the reinforcement beam deforms or crashes, a structure of the reinforcement beam is researched as in JPH08-20297 A and JP2007-290581A.

A bumper disclosed in JPH08-20297A includes a bumper reinforcement beam provided with a straight portion. The bumper reinforcement beam has a rectangular cross section partitioned by a wall connecting a front face and a rear face of the reinforcement beam. A plurality of long holes or circular holes is provided on a rear face of the straight portion along lines perpendicular to an extending direction of the beam in order to reduce a bending strength of the straight portion as illustrated in FIG. 1 or FIG. 6. The straight portion is proved in the middle of the reinforcement beam where the largest bending moment generates when an object collides.

Bending state is illustrated in FIG. 5 of JPH08-20297A. According to it, the reinforcement beam bends at the plural portions where the plurality of holes is provided. According to paragraphs 0010 and 0026, it is said that an energy absorption amount becomes larger than the reinforcement beam bending at a single position in a middle of the reinforcement beam because the reinforcement beam bends at plural positions, and deforming amount by a collision becomes smaller to reduce a damage to vehicles. Further, it is said that a plate thickness of the bumper can be made smaller to reduce a weight and cost.

The bumper of JPH08-20297A is problematic in that the long holes or the circular holes cause a plate configuring the bumper to rip from inner edge of the holes if an impact is applied, and prevents the reinforcement beam from smoothly plastically deforming or crashing due to a lack of a mechanical continuity on the reinforcement beam. This results in lowering in total energy absorption amount of the bumper.

A bumper disclosed in JP2007-290581A is provided with a mechanically weak portion on a reinforcement beam. The mechanically weak portion is formed by an annealing treatment after totally hot pressing the reinforcement beam. The mechanically weak portion is provided on bending portions (represented by a numeral 3 in FIG. 1) of the reinforcement beam or mounting portion (represented by a numeral 4 in FIG. 1) for a vehicle frame (claims 4 and 5). Claim 6 describes that the mechanically weak portion is provided on a vertical wall portion (represented by a numeral 8 in FIG. 2), which is a portion approximately parallel with respect to a load applying direction.

According to the description in paragraph 0020 of JP2007-290581A, the bending portions buckle before a middle portion buckles, which prevents lowering of a load caused by a collapse of a cross section and realizes an enough reactive force with respect to the load even though it greatly deforms. According to the description in paragraph 0015, a safety of a vehicle with respect to various loading condition is secured, a reinforcement member is manufactured at reduced cost, a developing cost of a vehicle is reduced since an adjustment in accordance with a size of a vehicle and in accordance with a load to be applied is facilitated by changing an arrangement of the mechanically weak portion. The bumper of JP2007-290581A is problematic in productivity since the annealing treatment inevitably accompanies a chilling treatment in which a temperature is slowly lowered.

### SUMMARY OF THE INVENTION

As mentioned above, known bumpers have problems in the total energy absorption amount and the productivity. The present invention provides a bumper having a high productivity and a large energy absorption amount owing to a smooth plastic deformation or crash. Further, the bumper of the present invention prevents a reinforcement beam from buckling at a portion where an obstacle hits because a buckled beam protruding backward possibly damages vehicle members such as a radiator, an engine or others if the buckled beam displaces backward.

Above said problem is solved by a following bumper. That is the bumper for a vehicle including a reinforcement beam made of steel; and support members protruding from a vehicle frame and supporting the reinforcement beam therebetween. The reinforcement beam is provided with a quenched portion provided at least over a portion where an obstacle hits the reinforcement beam. The reinforcement beam is further provided with unquenched portions next to the portion where the obstacle hits the reinforcement beam to sandwich the quenched portion. A mechanical strength of the unquenched portions is smaller than the mechanical strength of the quenched portion.

The unquenched portions are formed by preventing a temperature of the steel configuring the reinforcement beam from rising so that the temperature is kept below a transformation start temperature (AC1) while quenching. The temperature rising is prevented by various methods such as continuously or intermittently chilling a steel plate using a chilling member, or controlling heating pattern of the steel plate.

The reinforcement beam is made of steel or preferably made of a steel plate because the reinforcement beam is quenched or provided with the unquenched portions. The support members protrude from the vehicle frame. The support members and the vehicle frame maybe either separate bodies or an integral body. The support members may be configured as a member having a function of absorbing an impact energy. The support members may be made of metals, ceramics, or plastics.

Because the unquenched portions are provided next to the quenched portion where an obstacle hits the reinforcement beam to sandwich the quenched portion, the unquenched portions plastically deforms or crashes prior to the quenched portion in case the obstacle hits the reinforcement beam. Because the reinforcement beam deforms at the unquenched portions, the portion where the obstacle hits displaces backward together with left and right ends of the reinforcement beam where the support members are connected. Displacing amount become smaller in this deforming mode in which the portion where the obstacle hits displace together with the left and right portion than a deforming mode in which the reinforcement beam buckles.

It is preferable that the portion where the obstacle hits the reinforcement beam is set around a middle portion of the reinforcement beam in an extending direction (herein after simply referred to as “middle portion”), and the unquenched portions is symmetrically provided with respect to the middle portion of the reinforcement beam. According to this configuration, the reinforcement beam evenly displaces backward at right and left ends of the reinforcement beam, and the displacing amount around the middle portions becomes small.

It is preferable that the unquenched portions are provided at least on a front face of the reinforcement beam. According to this configuration, the reinforcement beam smoothly bends at the unquenched portions by crashing or plastically bending therefrom. The front face is a plane including a point or a line to which the obstacle hits. For example, if a cross section of the reinforcement beam is a hollow circular shape, the front face is a curved plane connecting upper and lower points of the hollow circular cross section.

It is preferable that the reinforcement beam has a hollow cross section having corners. According to this configuration, the front face to form unquenched portions is readily specified when manufacturing the bumper. The front face provided with the unquenched portions smoothly plastically deforms or crashes.

It is preferable that the position of the unquenched portions is determined with reference to a following equation as a guide.

L1/L2=S1/S2

L1 represents a length from the middle portion of the reinforcement beam to an inside of the supporting members. L2 represents a length from the inside of the supporting members to an inside of the unquenched portions. S1 represents the mechanical strength of the quenched portions. S2 represents the mechanical strength of the unquenched portions. According to this configuration, the reinforcement beam smoothly bends at inside of the unquenched portions to facilitate the middle portion of the reinforcement beam to displace together with the left and right ends of the beam.

More specifically, L1 represents a straight-lined distance from the middle portion of the reinforcement beam to an inside of the supporting members closest to the middle portion. L2 represents a straight-lined distance from the inside of the supporting members closest to the middle portion to an inside of the unquenched portions closest to the middle portion. If the inside of the unquenched portions or the out of the support members is not a liner shape, for example the unquenched portions are meandering, a meandering portion closest to the middle portion is “inside”.

According to the present invention, the reinforcement beam crashes or plastically deforms at the unquenched portions. This causes the quenched portion sandwiched by the unquenched portions to displace backward together with the left and right ends of the beam. According to this deforming, displacing amount becomes smaller than that of a bumper of prior art in which the reinforcement beam buckles and protrudes to backward. Further, according to the present invention, the total energy absorption amount becomes large and the reinforcement beam is prevented from displacing backward because the reinforcement beam smoothly plastically deforms or crashes without ripping from the unquenched portions.

According to the present invention, it does not take long time to form the unquenched portions because the unquenched portions are formed by chilling or preventing a temperature from rising. The bumper of the present invention is superior in productivity because it is easily manufactured in very short time

### BRIEF DESCRIPTION OF THE DRAWINGS

FIG. 1 is a perspective view illustrating an example of a bumper of the present invention. Forward of the bumper corresponds to the lower right direction of FIG. 1.

FIG. 2 is a front view of the bumper illustrated in FIG. 1.

FIG. 3 is a plain view of the bumper illustrated in FIG. 1.

FIG. 4 is a plain view illustrating the bumper of FIG. 1 collided with an obstacle.

FIG. 5 is a magnified end section corresponds to arrows A in FIG. 3.

FIG. 6 is a magnified end section corresponds to arrows B in FIG. 3.

FIG. 7 is a plain view illustrating a bumper of a prior art collided with an obstacle.

### DETAILED DESCRIPTION OF THE PREFERRED EMBODIMENTS

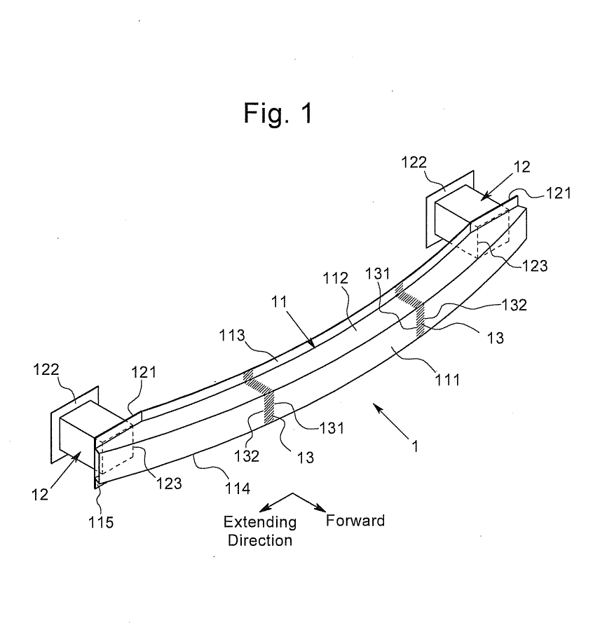

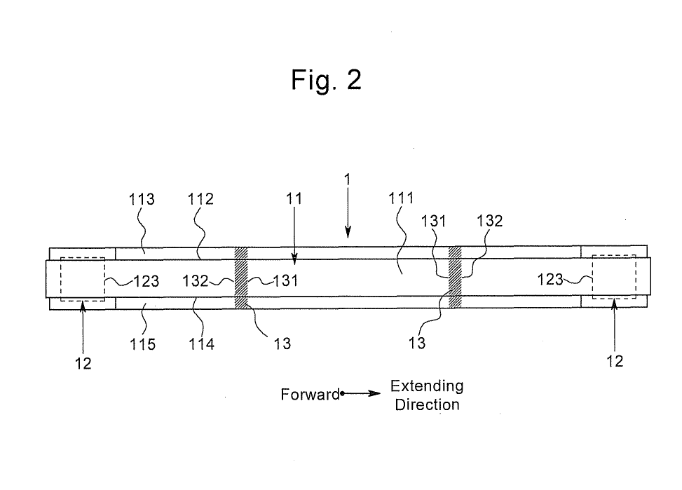

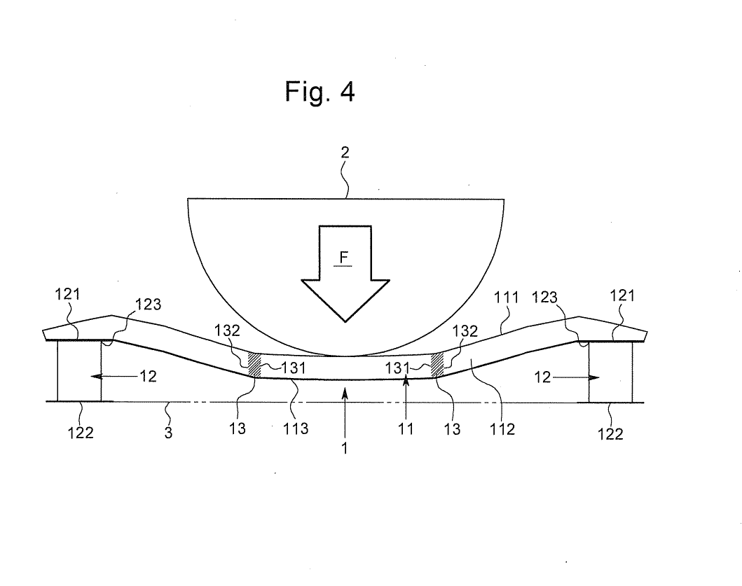

Preferred embodiments of the present invention is explained with reference to Figures. One example of the bumper of the present invention is illustrated in FIGS. 1 to 4. The bumper 1 of the present example is mounted on a front end of a vehicle. The bumper 1 may be mounted on a rear end of a vehicle. Forward and backward are interchanged in case the bumper 1 is mounted on the back end of the vehicle. The bumper 1 of the present example includes a reinforcement beam 11 made of steel and a pair of support members 12,12 protruding from a vehicle frame 3, which is illustrated in FIG. 4 with a two dot chain line. The pair of support members 12,12 supports the reinforcement beam 11 therebetween. The reinforcement beam 11 is totally quenched except for a pair of unquenched portions 13,13. The bumper 1 is connected to the vehicle frame 3 via a pair of connecting flanges 122,122 provided at backend of the pair of support members 12,12.

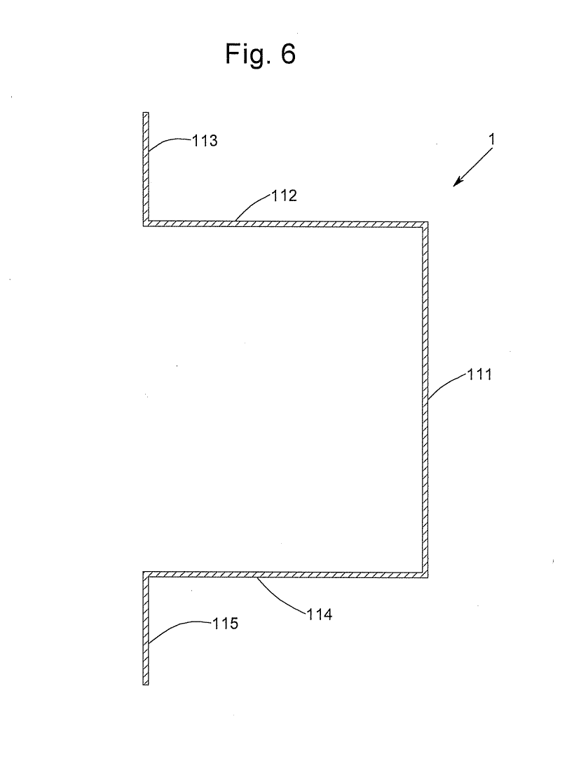

The reinforcement beam 11 includes a front face 111, an upper face 112 continuing from and upper end of the front face 111, a lower face 114 continuing from a lower end of the front face 111, an upper flange 113 continuing from a back end of the upper face 112 and a lower flange 115 continuing from a back end of the lower face 114. The front face 111, the upper face 112, the lower face 114, the upper flange 113 and the lower flange 115 are folded to shape a hat shape cross section whose back side is left opened (see FIG. 6) . The reinforcement beam 11 is made of a steel plate and has a hollow cross section having corners. The reinforcement beam 11 absorbs an impact energy generated by colliding an obstacle at a load F by plastically totally deforming the steel plate.

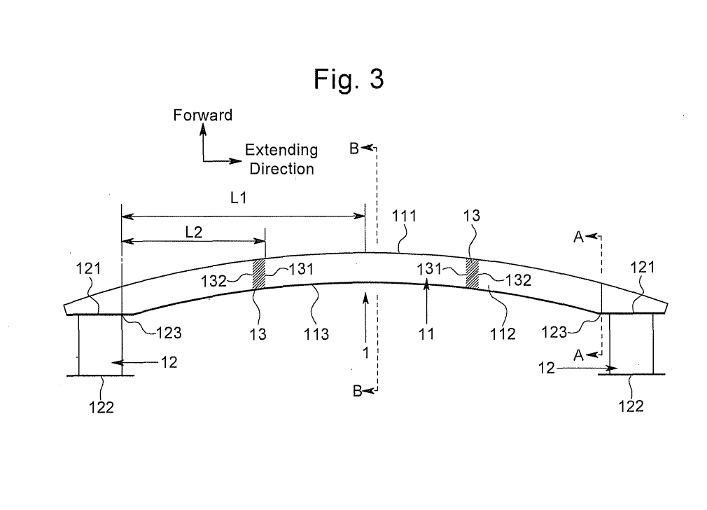

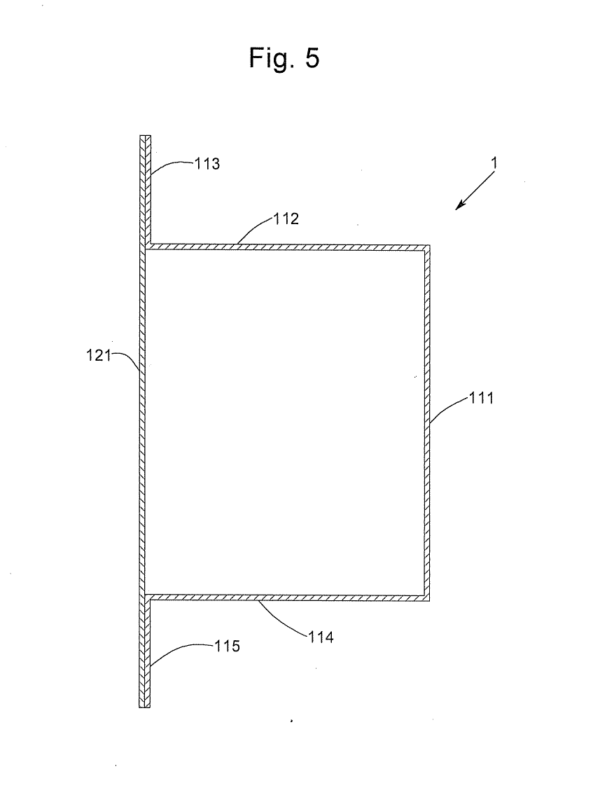

The reinforcement beam 11 of the present example has an arch shape in plain view as illustrated in FIG. 3. The front face 111, the upper face 112, the upper flange 113, the lower face 114 and the lower flange 115 are integrally bent to protrude forward from a horizontal line connecting the pair of support members 12,12. The upper flange 113 and the lower flange 115 at right and left ends of the reinforcement beam 11 are folded to form planes which are in parallel with the horizontal virtual line connecting upper ends of the pair of supporting members 12,12. As illustrated in FIG. 6, the, back side of the reinforcement beam 11 is left opened in an arch shaped region. The back side 1 at the left and right ends is closed with the connecting flanges 121,121 of the support members 12 as illustrated in FIG. 5. The connecting flanges 121,121 are welded to the upper flange 113 and the lower flange 115 in the present example. A connecting flange 121 having a rectangular shape in front view and provided at an front end of the supporting member 12 is connected to the flat portion of the reinforcement beam 11 by welding or bolting.

The reinforcement beam 11 is provided with a quenched portion. The quenched portion is provided at least over a portion where an obstacle hits the reinforcement beam 11. In the present example of FIG. 1, the obstacle 2 is supposed to hit around the middle portion of the reinforcement beam 11. Therefore, the quenched portion is provided over whole of the reinforcement beam 11 except for the pair of unquenched portions 13,13 to include the middle portion of the reinforcement beam 11. The pair of unquenched. portions 13,13 is provided next to the middle portion where the obstacle hits the reinforcement beam 11 to sandwich the quenched portion. The number of unquenched portion is two in the present example. For example, the number may be four or six as long as the unquenched portion forms a pair or pairs. Unquenched portions are provided over at least on the front face 111 of each surface configuring the reinforcement beam 11. In the present example, the pair of unquenched portions 13,13 is provided over the front face 111, the upper face 112, the upper flange 113, the lower face 114, and the lower flange 115. The unquenched portion 113 has a band shape enclosed by a pair of lines on an inside 131 and an outside 132, the pair of lines is in parallel with a backward or forward direction.

As illustrated in FIG. 3, in case L1 is defined as a length from the middle portion of the reinforcement beam 11 to an inside 123 of the supporting members 12,12, L2 is defined as a length from the inside 123 of the supporting members 12 to an inside 131 of the unquenched portions 13, S1 is defined as the mechanical strength of the quenched portions, and S2 is defined as the mechanical strength of the unquenched portions 13, a position of the unquenched portions 13,13 is determined with reference to a following equation.

L1/L2=S1/S2

L1 is determined based on a width of a vehicle. S1 is determined based on a mechanical strength required for a bumper. S2 is determined based on a capability of facility for conducting quenching. In the bumper 1 of the example illustrated in FIG. 1, S1 is set at 1600 MPa, S2 is set at 800 MPa, L1 is set at 800 mm considering half width of a vehicle. Therefore, it L2 is calculated as 400 mm using above equation. In the bumper 1 of the present example, considering the calculated value, the unquenched portions 13,13 are formed on the reinforcement beam 1 so that the length from the inside 123 of the supporting members 12,12 to an inside 131 of the unquenched portions 13,13 is 400 mm. Since the calculated value “400 mm” is a guide, the length may be differed, for example 390 mm or 410 mm. Width of the unquenched portions 13,13 is not particularly limited. The width of the unquenched portions 13,13 may be as wide as the outside 132 reaches to the support members 12,12.

The pair of lines on the inside 131 and the outside 132 of the unquenched portion 13 provided on the upper face 112, the upper flange 113, the lower face 114 and the lower flange 115 may be either straight, bent or meandering except for the boundary lines on the front surface 111 of the reinforcement beam 11 as far as the inside 131 of the unquenched portion 13 formed on the front face 111 of the reinforcement beam 11 satisfies above equation. A distance between the inside 131 and the outside 132 is not limited. In other words, a width of the unquenched portion 13 is not limited. The unquenched portion 13 may be made wider or narrower than the width of the example in FIG. 1.

The unquenched portions 13,13 are, for example, formed by putting chilling blocks on target portions of a flat steel plate which is shaped to be the front face 111, the upper face 112, the upper flange 113, the lower face 113 and the lower flange 115. The flat steel plate is heated with the chilling blocks put thereon so that the temperature of the unquenched portions 13,13 is kept below than a transformation start temperature (AC1) and whole of the reinforcement beam 11 except for the unquenched portions 13,13 are heated beyond a transformation complete temperature (AC3). Alternatively, heating of the steel plate is once halted for chilling. Namely, the flat steel plate is heated to reach at predetermined temperature, heating of the flat steel plate is once halted, the chilling blocks are put on target portions, and the heating of the flat steel plate is resumed after removing chilling blocks to keep the temperature of the unquenched portions 13,13 below AC1 and to rise the temperature of the quenched portion beyond AC3. The unquenched portions 13,13 correspond to potions where the chilling blocks are put on. The flat steel plate heated beyond AC3 may be hot-pressed to shape the reinforcement beam 11.

The support members 12 of the present example form a pair. The support members 12,12 have a rectangular cross section made of a steel plate. The support members 12,12 are welded with the connecting flanges 121,122 at their front end and rear end. The connecting flanges 121,122 are made of a steel plate and have a rectangular shape in front view. The connecting flange 121 is abutted to the upper flange 113 and the lower flange 115. The flanges 113,115,121 are connected by welding or bolting. The connecting flange 122 is abutted to the vehicle frame 3. The connecting flange 122 and the vehicle frame 3 are connected by welding or bolting. The support members 13,13 absorb an impact energy applied by an obstacle 2 colliding the reinforcement beam by plastically deforming and compressing themselves in backward direction.

It is required that the unquenched portions 13,13 plastically deform before the quenched portions and the support members 12,12 deform. Therefore, it is preferable that the mechanical strength of the unquenched portions 13,13 is made relatively smaller than the quenched portion and the supporting members 12,12. This is realized by totally quenching the reinforcement beam 11 except for the unquenched portions 13,13 and thickening the steel plate configuring the support members 12,12. By adapting this configuration, the unquenched portions 13,13 plastically deform before the quenched portions and the support members 12,12 deform.

In case the obstacle 2 collides with the bumper 1 of the present example and the load F is applied to the middle portion, the reinforcement beam 11 collided with the obstacle 2 deforms at the pair of unquenched portions 13,13 as illustrated in FIG. 4. The middle portion sandwiched by the pair of unquenched portions 13,13 displaces backward without buckling. Because the reinforcement beam 11 does not buckle at the middle portion and displace backward in the buckled state, the reinforcement beam 11 does not hit the vehicle frame 3. Portions outside the pair of unquenched portions 13,13 do not pulled toward the middle portion because the middle portion mainly displaces to backward by plastically deforming the pair of unquenched portions 13,13. This prevents the pair of support members 12,12 from inclining or crashing towards inside. This contribute to securing an intact function, which absorbs the impact energy by compressing the support members 12,12 in backward direction, of the support members 12.

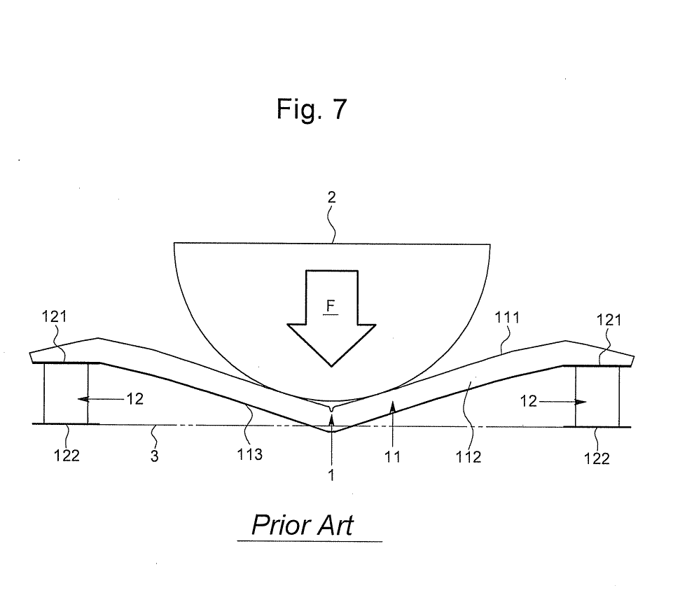

A plain view of a bumper of the prior art is illustrated in FIG. 7. A reinforcement beam 11 is totally quenched in this bumper. In case the obstacle 2 collides with the reinforcement beam 11, the reinforcement beam 11 buckles at a middle portion where the obstacle 2 hits and the load F is applied. The buckled portion protrudes and hits a vehicle frame 3 as illustrated with a two-dot chain line. Because the middle portion buckles and displaces backward, portions outside the middle portion may be pulled toward the middle portion. This cause the support members 12 to incline or crash toward inside. This impairs an intact function of the support members 12,12 as an impact energy absorbing members.

The bumper 1 of the present invention plastically deforms or crashes the reinforcement beam 11 to secure the intact function of the support members 12,12 in case the support members 12 function as the impact absorbing members by plastically deforming or crashing themselves. The reinforcement beam 11 of the present invention does not crack. The reinforcement beam 11 and the support members 12,12 of the present invention absorb an enough impact energy as the impact absorbing members to enlarge the total energy absorption amount.

1. A bumper for a vehicle comprising:
a reinforcement beam made of steel; and
support members protruding from a vehicle frame and supporting the reinforcement beam therebetween;
wherein the reinforcement beam is provided with a quenched portion provided at least over a portion where an obstacle hits the reinforcement beam, the reinforcement beam is further provided with unquenched portions next to the portion where the obstacle hits the reinforcement beam to sandwich the quenched portion, and a mechanical strength of the unquenched portions is smaller than the mechanical strength of the quenched portion.

2. The bumper for a vehicle according to claim 1, wherein the portion where the obstacle hits the reinforcement beam is around a middle portion of the reinforcement beam in an extending direction, and the unquenched portions is symmetrically provided with respect to the middle portion of the reinforcement beam.

3. The bumper for a vehicle according to claim 1, wherein the unquenched portions are provided at least on a front face of the reinforcement beam.

4. The bumper for a vehicle according to claim 1, wherein the reinforcement beam has a hollow cross section having corners.

5. The bumper for a vehicle according to claim 2, wherein the position of the unquenched potions is determined with reference to a following equation as a guide,
L1/L2=S1/S2
wherein L1 represents a length from the middle portion of the reinforcement beam to an inside of the supporting members, L2 represents a length from the inside of the supporting members to an inside of the unquenched portions,
S1 represents the mechanical strength of the quenched portions, and
S2 represents the mechanical strength of the unquenched portions.
